(19) United States
(12) Patent Application Publication
(10) Pub. No.: US 2025/0334097 A1
(43) Pub. Date: Oct. 30, 2025

(54) CONTROLLING DIFFUSION OF A WAKE GENERATED BY A WIND TURBINE

(71) Applicant: EQUINOR ENERGY AS, Stavanger (NO)

(72) Inventor: Andreas KNAUER, Lysekloster (NO)

(21) Appl. No.: 18/865,203

(22) PCT Filed: May 12, 2023
(86) PCT No.: PCT/NO2023/050110

§ 371 Date: Nov. 12, 2024

(30) Foreign Application Priority Data
May 13, 2022 (GB) 2207033.8

(51) Int. Cl. F03D 7/04; F03D 7/02; F03D 13/25

(52) U.S. Cl. CPC F03D 7/049; F03D 7/0276; F03D 7/028; F03D 13/256; F05B 2240/93; F05B 2240/95; F05B 2270/204; F05B 2270/32; F05B 2270/321

(57) ABSTRACT

A method of controlling diffusion of a wake generated by a horizontal axis wind turbine is provided. The wind turbine comprises a rotor having a hub and a plurality of rotor blades 20 mounted to the hub. Each rotor blade 20 has a radially-outer, energy-extraction portion 32 and a radially-inner, ventilation portion 30, wherein the radially-inner ventilation portion 30 is shaped to, in use, extract reduced levels of kinetic energy from the wind compared to the radially-outer energy extraction portion 32 in order to ventilate a central area 34 of the wake. Diffusion of the wake is controlled by adjusting the tip speed ratio of the rotor in order to modify turbulent mixing within the wake.

The present invention relates to controlling the wake that is formed behind a wind turbine as wind passes through the rotor area of the turbine, and particularly to methods and systems for controlling the diffusion of the wind turbine wake.

Horizontal-axis wind turbines generally have a horizontal main rotor shaft and an electrical generator at the top of a tower. Horizontal-axis wind turbines used for commercial production of electrical power are usually three-bladed and are yawed into the wind by computer-controlled motors. The towers often range from 70 to 140 meters tall and the blades typically have a length from 50 to 120 meters. However, larger wind turbines are in development, for example having heights of up to 220 meters and blade lengths of over 100 meters.

During operation, the velocity of the wind generates lift on the blades, causing the rotor to rotate, which in turn drives an electric generator. The extraction of energy, however, slows down the wind and causes a wake (or shadow) to form behind the turbine. The wind within the wake has a slower velocity than wind that did not pass through the rotor area. Moreover, the slower velocity of the wind in the wake relative to the velocity of the wind unaffected by the rotor causes the diameter of the wake to expand beyond the diameter of the rotor (i.e. wake expansion).

Using an array of wind turbines in a relatively small geographic region, i.e. a wind farm, offers numerous advantages, such as cheaper construction costs, shared infrastructure, and lower maintenance costs than if the same number of wind turbines were built individually. However, the proximity of the wind turbines to others within the array affects their efficiency. Specifically, the wake of one turbine will reduce the power output of a downwind turbine because the downwind turbine receives a relatively slower wind velocity.

An individual wind turbine in full wake conditions may experience a power output loss of more than 50%, compared to the power output of a turbine positioned upwind. However, averaged across the entire farm, wake losses may typically be around 10-15%.

Further downwind of the turbine, the wind velocity within the wake increases due to the transfer of kinetic energy from the wind surrounding the wake by turbulent mixing. Turbulent mixing occurs naturally due to the velocity difference between the air flowing inside and outside of the wake, as well as due to environmental and/or met-ocean conditions, such as the terrain roughness or wave height. Thus the problem of wake-induced efficiency loss can be reduced by separating the wind turbines further apart, thereby increasing the efficiency of the array. For this reason, in most offshore wind turbine farms, a turbine spacing of about 6 to 10 rotor diameters is normal. In practice, this spacing defines the upper limit for the most efficient power production of the farm.

It would be desirable to increase the efficiency of the wind turbines in the array, and hence the power output of the wind farm, without increasing the area of the wind farm. WO2016/200277 describes a rotor blade for a horizontal-axis wind turbine that is intended to reduce the effects of wind turbine wake on downwind turbines in order to address this issue. The blade has a radially outer portion that is shaped similar to a typical rotor blade and is designed to extract maximum energy from the wind. Radially inwards of this portion, the blade has a radially inner portion that is shaped to, in use, extract low levels of energy from the wind in order to ventilate a central area of the wake. This blade configuration means that, in use, the central region of the wake will contain more kinetic energy compared to the wake from a more conventional rotor design. This increased wind flow velocity at the centre of the wake will generate additional shear stresses, with corresponding turbulence development, which gives rise to increased wake diffusion. Since the radially inner region of the blade is designed to extract low levels of energy from the wind, the efficiency and power output of a turbine with these rotor blades is reduced relative to a turbine comprising conventional rotor blades. However, this loss of efficiency may be outweighed by the benefit of reduced wake effects on downwind turbines, which can lead to an overall increase in efficiency across an array of turbines.

However, the benefit to downwind turbines that is caused by the increased turbulent mixing of the wake is not constant and can vary depending on conditions, such as wind speed and wind direction. As a result, in some wind conditions the benefit obtained by the reduced wake effects on downwind turbines can be overshadowed by the loss in efficiency of the individual wind turbines that will result from the radially-inner portions of the blades extracting low levels of energy from the wind.

In one aspect, the present invention provides a method of controlling diffusion of a wake generated by a horizontal axis wind turbine, wherein the wind turbine comprises a rotor having a hub and a plurality of rotor blades mounted to the hub; wherein each rotor blade has a radially-outer, energy-extraction portion and a radially-inner, ventilation portion; and wherein the radially-inner ventilation portion is shaped to, in use, ventilate a central area of the wake by extracting reduced levels of kinetic energy from the wind compared to the radially-outer energy extraction portion, the method comprising: adjusting the tip speed ratio (TSR) of the rotor so as to modify turbulent mixing within the wake.

In use, the centre of the rotor extracts reduced levels of kinetic energy from the wind so the velocity of the air within the wake immediately behind the rotor will be greater at the centre of the wake compared to at the radially-outer regions of the wake. In this regard, the central region of the wake can be said to be “ventilated”. The increased wind flow velocity at the centre of the wake generates additional shear stresses, which develops turbulence within the wake and gives rise to increased wake diffusion.

It should be appreciated that “extracting kinetic energy” refers not only to extraction of useful energy to drive the turbine, but also to energy extraction due to drag or the like. For example, a root section having a circular shape will generate significant drag, which extracts kinetic energy from the wind and decreases ventilation.

The TSR of a wind turbine is the ratio between the tangential speed of the tip of a blade and the actual velocity of the wind. Wind turbines are typically designed to operate at an optimal TSR to generate maximum power output. The optimal, or design, TSR is the TSR at which the maximum power coefficient (Cₚ) of the wind turbine is reached. For conventional wind turbines, the TSR is typically maintained at the design TSR below rated wind speed in order to maximise power output, but may be adjusted (typically below the design TSR) above rated wind speed in order to produce a constant power output.

The power coefficient Cₚ is a measurement of the efficiency of energy extraction, and is defined by the ratio of extracted power to the wind power, for a given swept area. This can be determined for the whole swept area of a rotor or only for a portion of the whole swept area, for instance an annulus swept by a segment of a blade. Although it can be exceeded locally, the maximum, theoretical power coefficient that can be achieved over the entire swept area of a horizontal-axis wind turbine is about 59.3%, known as the Betz limit. In practice, even at the optimal tip speed ratio, modern wind turbines rarely achieve a power coefficient over 50%, and more normally achieve power coefficients of around 45% to 48%.

It has been found that the ventilation effect of the rotor, and hence diffusion of the wake, can be varied by adjusting the TSR of the rotor. Hence, it is possible to operate the rotor at a TSR that achieves an optimum balance between the power output of the wind turbine and the wake diffusion effects of the rotor.

The rotor blades may be shaped so that the design TSR of the rotor is 5 to 12, preferably 7 to 11, e.g. about (e.g. +/−1) 10.

The rotor blades may be shaped so as to produce a more uniform power coefficient over the total swept area of the rotor when the rotor is operating at the design TSR compared to when the rotor is operated at a TSR away from the design TSR (e.g. at a TSR higher than the design TSR), at least for a range of TSR values above and/or below the design TSR. In one embodiment, the rotor blades may be shaped to produce a more uniform power coefficient over the total swept area of the rotor when the rotor is operated at the design TSR compared to when the rotor is operated above the design TSR. As a result, the velocity of the air within the wake directly behind the rotor will be less uniform across the total swept area of the rotor when the rotor is operated away from the design TSR compared to when the rotor is operated at the design TSR.

For example, at the design TSR, the velocity of the wind directly behind the radially-inner swept area of the rotor (corresponding to the radially-inner region of the rotor blades) may be 105% to 115% the velocity of the wind directly behind the radially-outer swept area of the rotor (corresponding to the radially-outer region of the rotor blades). However, at TSR away from the design TSR, preferably above the design TSR, the velocity of the wind directly behind the radially-inner swept area of the rotor may be 115% to 135% the velocity of the wind directly behind the radially-outer swept area of the rotor.

This increase in the difference between the velocity of the wind at the radially-inner and radially-outer portions of the wake may lead to increased shear stresses, with a corresponding increase in turbulence development, giving rise to increased wake diffusion. As a result, the distance over which the wake takes to diffuse will reduce and its effect on wind turbines positioned downwind of the wind turbine will be reduced. Hence, wake induced efficiency losses in a downwind turbine can be reduced. It will be appreciated that operating the rotor at increased TSR in order to increase wake diffusion will lead to a reduction in the power coefficient of the wind turbine, and may lead to a reduction in the power output of the wind turbine. However, this reduction in power output may be outweighed by the increase in power output by the downwind turbine.

The rotor blades may be shaped so that, when the rotor is operating at the design TSR, the rotor achieves a local power coefficient of 5% to 10% for the area swept by the radially-inner portion.

The rotor blades may be shaped so that, when the rotor is operating at the design TSR, the rotor achieves a local power coefficient of 40% to 50% for the area swept by the radially-outer portion.

The rotor blades may be shaped so that, when the rotor is operating at above the design TSR, the rotor achieves a local power coefficient of 5% or less for the area swept by the radially-inner portion.

The rotor blades may be shaped so that, when the rotor is operating at above the design TSR, the rotor achieves a local power coefficient of at least 45% for the area swept by the radially-outer portion.

As discussed above, the power coefficient over the total swept area of the rotor may be more varied (compared to when operating at the design TSR) when the rotor is operating within a range of TSR above the design TSR, for instance at TSR 1 to 4 above, or preferably 2 to 3 above, the design TSR. Outside of this range, the power coefficient of the total swept area of the rotor may become more uniform and the diffusion effect of the rotor may be reduced. Hence, if the rotor has a design TSR of 8, for example, the power coefficient over the total swept area of the rotor may be more varied when the rotor is operated at a TSR of between 8 and 12 compared to when the rotor is operated at the design TSR.

The method may comprise operating the rotor at above the design TSR, preferably within the range discussed above. This may provide a more beneficial wake diffusion effect, for instance leading to increased turbulent mixing within the wake, and therefore increased wake diffusion, compared to when the rotor is operated at the design TSR. Hence, the method may comprise increasing the TSR of the rotor, preferably above its design TSR, in order to increase turbulent mixing within the wake. The rotor may be operated at above design TSR and/or the TSR of the rotor may be increased (e.g. above design TSR) when it has been determined that increased diffusion of the wake is required. As discussed in more detail below, this may be when the wake of the wind turbine (e.g. when operated at or below design TSR) has a detrimental impact on a downwind wind turbine and/or power output of a wind farm comprising the wind turbine.

It will be appreciated that, whilst operating the rotor above its design TSR will lead to increased wake diffusion, it will also lead to a reduction in the power coefficient of the rotor. Hence increasing the TSR may lead to a reduction in the power output of the wind turbine. This may be acceptable in some situations, for instance when it is more important to increase wake diffusion than to produce maximum power, although in other situations it may be desirable to limit power loss. Hence, the method may comprise reducing the TSR of the rotor, preferably towards its design TSR, so as to decrease turbulent mixing within the wake and increase the power output of the wind turbine.

The method may comprise operating the rotor at its design TSR in order to maximise the power output of the wind turbine. Hence, the method may comprise decreasing the TSR of the rotor to its design TSR (i.e. reducing the TSR of the rotor from a TSR above its design TSR to the design TSR) in order to optimise the power output of the wind turbine.

The rotor may be operated at its design TSR and/or the TSR of the rotor may be reduced (e.g. to the design TSR) when it has been determined that increased diffusion of the wake is not required, i.e. when it is desirable to maximise power output of the wind turbine. As discussed in more detail below, this may be when the wake of the wind turbine has a little or no detrimental impact on a downwind wind turbine and/or power output of a wind farm comprising the wind turbine.

The TSR of the rotor may be controlled by controlling the blade pitch of the rotor blades. Adjusting the TSR of the rotor may comprise adjusting the blade pitch of the rotor blades. Each of the rotor blades may be pitched collectively by the same amount. The TSR may be reduced by pitching the blades so as to reduce the aerodynamic lift generated by the blades as the wind passes through the rotor. As a result, the rotational velocity of the rotor may be reduced. This pitching may comprise increasing the blade pitch, i.e. making the blades more parallel to the wind direction. In order to increase the TSR, the blades may be pitched so as to increase the aerodynamic lift generated by the blades as the wind passes through the rotor. This may be achieved by reducing the blade pitch, i.e. making the blades less parallel to the wind. This may result in an increase in the rotational velocity of the rotor.

The wind turbine may comprise a generator coupled to the rotor to generate electrical power. The TSR of the rotor may be controlled by controlling the torque presented to the rotor by the generator. Adjusting the TSR of the rotor may comprise adjusting the torque presented to the rotor by the generator. The TSR of the rotor may be reduced by increasing the resistance of the generator in order to apply a greater resistive torque to the rotor. Conversely, the TSR of the rotor may be increased by reducing the resistance of the generator in order to apply a smaller resistive torque to the rotor.

The method may comprise controlling the TSR of the rotor based on a property of the wind at the wind turbine, such as the wind speed and/or the wind direction. It will be appreciated that it is often desirable to maximise power output of wind turbines, and hence it is desirable to maximise the amount of time that the wind turbine can be operated at the design TSR. However, in certain circumstances, operating the wind turbine at the design TSR may lead to downwind wind turbines experiencing unacceptable wake induced power output losses, which may outweigh the power output gains that can be experienced as a result of operating the upwind wind turbine at the design TSR. Hence, the rotor may be operated at a TSR based on a wind direction and/or a wind speed so as to achieve an optimum balance between the power output of the wind turbine and the effect that its wake has on the efficiency of downwind turbines. This may comprise adjusting the TSR of the rotor based on a property of the wind at the wind turbine (e.g. the wind speed and/or the wind direction).

The method may comprise controlling the TSR of the rotor based on the location of the wind turbine relative to the locations of one or more other wind turbines, for example other turbines positioned within a radius of 20 rotor diameters from the wind turbine. The known locations of other wind turbines near to the wind turbine may be used together with a known property of the wind in order to optimise the TSR of the wind turbine to balance the power output of the wind turbine with the effect that its wake has on downwind turbines. This may comprise adjusting the TSR of the rotor based on the location of the wind turbine relative to the locations of one or more other wind turbines.

The method may comprise controlling the TSR of the rotor so that wake induced power output losses experienced by a wind turbine positioned downwind, within the wake (i.e. the power output loss compared to the power output of the upwind wind turbine) is less than a predetermined threshold. The predetermined threshold may be 50%, preferably 40%, more preferably 30%. The TSR at which the rotor should be operated in order to achieve this may depend on the direction of the wind at the wind turbine, the wind velocity, and the relative position of the downwind turbine, as discussed above. This may comprise adjusting the TSR of the rotor to a value so that wake induced power output losses experienced by a wind turbine positioned downwind within the wake is less than the predetermined threshold.

It will be appreciated that it is desirable to operate the wind turbine to produce optimum power output whilst also minimising the effect that its wake has on downwind turbines. Hence, in addition to limiting wake induced efficiency losses experienced by downwind turbines, the method may comprise controlling the TSR of the rotor to maximise the power coefficient of the rotor, and therefore the power output of the wind turbine, whilst maintaining the wake induced power output losses experienced by a downwind turbine below the predetermined threshold. In this way it may be possible to maximise the power output of an array of wind turbines, such as a wind farm. This may comprise adjusting the TSR of the rotor to a value to maximise the power coefficient of the rotor whilst maintaining the wake induced power output losses experienced by a downwind turbine below the predetermined threshold.

It will be understood from the above description that the present invention can be utilised to control the rotor of a wind turbine to balance the energy production of the wind turbine with wake diffusion effects of the rotor. In a preferred embodiment, the rotor may be operated at its design TSR in order to maximise the power output of the wind turbine when it is determined that the wake effects of the wind turbine are acceptable. As discussed above, this may be when wake induced power losses of a downwind wind turbine are below a predetermined threshold. If it is determined that the wake effects of the wind turbine (when operated at design TSR) are unacceptable, the rotor may be operated at above its design TSR in order to increase diffusion of the wake. This may comprise increasing the TSR of the rotor to above its design TSR. In this way the negative effects of the wake, e.g. on a downwind wind turbine, can be reduced.

Adjusting the TSR as discussed above for modifying the turbulent mixing within the wake of the turbine may be carried out when the speed of the wind at the wind turbine is below the rated wind speed. Different controls may be applied when the speed of the wind is at or above rated wind speed. That is, adjusting the TSR as discussed above for modifying the turbulent mixing within the wake of the turbine may only be performed when the speed of the wind is below the rated wind speed.

At wind speeds at and above the rated wind speed, the TSR of the rotor may be controlled so that the wind turbine produces a constant output power. This is typically done to limit the amount of energy that is extracted from the wind by the rotor blades and helps to prevent the rotor, and other components of the wind turbine structure, from being subjected to excessive loads that could lead to damage. This can also help to prevent excessive power production in the generator. This may be achieved by operating the rotor below the design TSR. Hence, at and above the rated wind speed, the method may comprise operating the rotor below the design TSR. This may comprise reducing the TSR, preferably below the design TSR.

By controlling the wind turbine in this way, at wind speeds at and above the rated wind speed only a relatively small amount of kinetic energy may be extracted from the wind as it passes through the rotor. Hence, the speed of the wind may be only marginally effected by the rotor. For instance, at wind speeds at and above the rated wind speed, the speed of the wind immediately downwind of the rotor may be at least 80% or 90% of the wind speed immediately upwind of the rotor. This may mean that a significant wake is not generated behind the rotor at and above rated wind speed, and only limited wake induced efficiency losses, if any, may be experienced by turbines positioned downwind. Accordingly, at wind speeds at and above rated wind speed, it may not be necessary to operate the wind turbine to modify turbulent mixing within the wake.

The rated wind speed of the wind turbine may be 10 m/s to 14 m/s, preferably 11 m/s to 12 m/s.

The method may comprise determining a property of the wind at the wind turbine, for instance the wind speed and/or direction at the wind turbine. The wind turbine may comprise one or more sensors for measuring the property or properties of the wind. Alternatively, or in addition, the property or properties of the wind may be derived from external data. For instance, the property or properties of the wind at the wind turbine may derived from data supplied from a weather station and/or from weather forecasts.

The rotor may comprise at least two, preferably three, rotor blades mounted to the hub.

The radially-inner portion may have an axial length of between 15% and 40% of the total length of the blade, preferably between 20% and 30% of the length of the blade, and most preferably between 20% and 25% of the length of the blade.

The radially-outer portion may have an axial length of at least 40% of the total length of the blade, preferably at least 50% of the length of the blade.

It is noted that the terms radially-outer and radially-inner are relative to one another and as such may not be the radially-outermost and radially-innermost portions of the rotor. In particular, the radially-outer portion may not include a tip portion of the blade, where tip effects must be accounted for. Also, a transition portion may be provided between the radially inner portion and the radially-outer portion. The transition portion preferably transitions smoothly between the shape of the radially-outer portion of the blade to the shape of the radially-inner portion of the blade. By “smoothly” it will be appreciated that the transition is gradually over its length and does not include instantaneous changes in shape. The axial length of the transition portion may be between 5% and 10% of the total length of the blade.

The greater the length of the radially-inner portion, the greater the ventilation effect and the more effective the dissipation of the wake. However, if too great a portion of the swept area has low energy extraction, then the loss of efficiency of the individual wind turbines may outweigh the benefit of reduced wake effects on downstream turbines. Also, if the ventilation area is large, then secondary effects such as tip and root vortices will become more prominent. The above ranges have been found to be optimum balance between power output and wake diffusion effects.

The rotor blades may have a length of at least 50 metres, more preferably at least 75 m, and yet more preferably more than 100 m.

Preferably, both the radially-inner portion of the blades and the radially-outer portion of the blades have an aerofoil shape. It will be appreciated that the aerofoil shape of the radially-inner portion of the blades may differ from the aerofoil shape of the radially-outer portion of the blades.

The radially-inner portion of the blade is preferably twisted from an optimal blade angle for extracting energy from the wind. That is to say, the radially-inner portion may have a local blade twist angle that is not at the optimum angle for extracting maximum energy from the wind, at least when the rotor is operated at the design TSR. The radially-inner portion may be twisted to minimise drag and/or the lift that is generated from the wind at the design TSR. This is contrary to conventional turbine blade design, in which a radially inner portion extracts slightly lower energy than the radially outer portion due to structural requirements. The blade root is typically subjected to large bending moments, so it is conventional for the blade root be have a reduced chord length and a more circular cross-sectional shape. This provides the blade root with the necessary structural strength but less aerodynamic performance. Typically, such prior art blades will still seek to extract maximum energy within their design constraints, and so will still be oriented at an optimal local blade twist angle. Such blades do not create a ventilation effect sufficient to enhance diffusion of the wake.

The transition portion preferably transitions smoothly from a local blade twist angle and/or aerodynamic shape of the radially-outer portion to a local blade twist angle and/or aerodynamic shape of the radially-inner portion.

The radially-inner portion of the blade is preferably shaped for generating minimal drag when the rotor is operating at, or above, its design TSR. In this way, the wake diffusion effect of the rotor can be maximised by allowing air to pass, with minimal disturbance, through the central area of the rotor.

The radially-outer portion is preferably shaped to extract high levels of energy from the wind, at least at and above the design TSR of the rotor. Thus, although the blade includes a portion extracting low energy at its centre, the outer portion of the blade (covering most of the swept area) may still extract high levels of energy achieving a high overall power coefficient for the blade.

The radially-outer portion of each blade may be shaped such that a local blade twist angle and/or local aerodynamic blade shape at each point along the radially-outer portion of the blade is approximately optimal (e.g. within 2°, and preferably within) 1° for extracting energy from the wind, when the rotor is operating at its design TSR.

The rotor blades may be shaped to achieve, in use when the rotor is operating at its design TSR, an overall power coefficient of at least 30%, preferably at least 35%, more preferably at least 40% and most preferably at least 43%. Thus, the rotor still has a relatively high power coefficient, despite the fact that low energy is extracted from the ventilated centre region.

The wind turbine may be an offshore wind turbine, preferably a floating offshore wind turbine. This method is particularly applicable to offshore wind turbines because of the relatively low terrain roughness, typically having roughness lengths of about Z₀=0.0002 m. The low terrain roughness means that the wind experiences low natural turbulence and so wakes diffuse over a longer distance. The wind turbine may, however, alternatively be an on-shore wind turbine. This method may also be particularly beneficial for application in on-shore areas having terrain roughnesses in the same range as offshore sites, such as smooth arctic terrain without vegetation. For example, areas with roughness lengths of below Z₀=0.005 m.

In a second aspect, the invention provides a horizontal-axis wind turbine comprising: a tower; a rotor mounted at the top of the tower, wherein the rotor comprises a hub and a plurality of rotor blades mounted to the hub, each rotor blade having a radially-outer, energy-extraction portion and a radially-inner, ventilation portion, wherein the radially-inner ventilation portion is shaped to, in use, ventilate a central area of the wake by extracting reduced levels of kinetic energy from the wind compared to the radially-outer energy extraction portion; and a controller configured to control the wind turbine in accordance with the method described above.

The controller is preferably configured to perform one or more or all of the optional and preferable features discussed above in relation to the first aspect of the invention.

The wind turbine preferably includes one or more or all of the optional or preferable features described above in relation to the first aspect.

It will be appreciated that the wind turbine of this aspect of the invention will benefit from the same technical advantages discussed above in relation to the method of the first aspect. Hence, in order to avoid repetition these have not been duplicated below.

The controller may be arranged to control the TSR of the wind turbine based on the wind direction and known locations of other wind turbines relative to the wind turbine. For instance, the controller may be arranged to take into consideration the position of other wind turbines near to the wind turbine, e.g. within 20 rotor diameters of the wind turbine, when determining the TSR for the rotor. For this purpose, the controller may comprise a memory for storing data relating to the location of other wind turbines relative to the location of the wind turbine.

The wind turbine may comprise one or more sensors for measuring the direction and/or velocity of the wind at the wind turbine. The one or more sensors are preferably arranged in communication with the controller to pass wind direction data and/or wind velocity data to the controller.

Alternatively, or in addition, the wind turbine may comprise a wireless transceiver for wirelessly receiving weather data (e.g. wind speed and/or wind direction) from a source external to the wind turbine. For instance, the wind turbine may receive weather data from a nearby weather station. The controller may be arranged to receive weather data obtained via the transceiver and use this data when determining the operational TSR of the rotor.

The wind turbine may comprise an offshore wind turbine, preferably a floating offshore wind turbine. The floating offshore wind turbine may be mounted on a floating platform, such as a spar buoy.

It will be appreciated that the above described method and wind turbine may have particular benefits for wind turbines arranged in arrays within a relatively small geographic region, i.e. a wind farm. The ability to adjust the wake that is generated by the wind turbines within the array could be advantageously used to optimise power production of the array as a whole. Hence, in a third aspect, the invention provides a wind farm comprising an array of horizontal-axis wind turbines, at least one of the wind turbines being a wind turbine as described above.

One or more or all of the wind turbines in the array may comprise a wind turbine as described above.

The wind farm is preferably an offshore wind farm. Alternatively, the wind farm may be an on-shore wind farm.

The wind farm may be located in a region having a roughness length of below Z₀=0.005 m.

A wind farm incorporating wind turbines arranged to operate in accordance with the above described method can achieve a noticeable increase in efficiency by operating at an optimum balance between peak power output of the individual turbines and their wake diffusion effects. In this way, wake induced efficiency losses within the array can be reduced and the efficiency of the wind farm can be increased.

In another aspect, the invention provides a method of optimising power production of a wind farm comprising a plurality of horizontal axis wind turbines, the wind turbines comprising a rotor having a plurality of rotor blades, each rotor blade having a radially-outer, energy-extraction portion and a radially-inner, ventilation portion, wherein the radially-inner ventilation portion is shaped to, in use, ventilate a central area of the wake by extracting reduced levels of kinetic energy from the wind compared to the radially-outer energy extraction portion, the method comprising: determining the effect that the wake of each wind turbine has on the efficiency of the wind farm; and adjusting the tip speed ratio of the rotor of at least one of the wind turbines to modify turbulent mixing within its wake and increase the efficiency of the wind farm.

The method may comprise any one or more of the method steps described above.

The wind turbines may be a wind turbine as described above, and/or the wind farm may be a wind farm as described above, and may include any one or more of the optional features described above.

It will be appreciated that it is possible to optimise the efficiency of the wind farm by controlling the tip speed ratio of the wind turbine(s) to minimise the effect of wake induced efficiency losses.

Determining the effect of the wake of each turbine may comprise using properties of the wind, for instance the wind speed and/or wind direction at the wind turbine, and the relative positions of the wind turbines to determine the effect that the wake produced by each wind turbine has on other wind turbines in the wind farm. These parameters may be used to evaluate the effect that the wake of a wind turbine has on the power produced by other turbines within the wind farm, and could be used to infer the effect that the wakes have on the total power output of the wind farm. This may comprise modelling the wind farm. The model may use data representative of the properties of the wind and the positions of the wind turbines within the wind farm in order to determine the effect of the wakes on the other wind turbines. The properties of the wind may be obtained by one or more sensors positioned on one or more of the wind turbines.

The method may comprise controlling the TSR of each of the wind turbines in the wind farm to reduce wake induced efficiency losses and maximise the efficiency of the wind farm. This may include operating one or more wind turbines at above their respective design TSR. One or more of the wind turbines (e.g. those not being operated above their design TSR) may be operated at their design TSR. It will be appreciated that controlling the TSR of the wind turbines may comprise increasing and/or decreasing the TSR of individual wind turbines, as necessary.

In yet another aspect, the invention provides a computer program product comprising computer readable instructions that, when executed, will cause a controller to control a horizontal-axis wind turbine in accordance with the method described above, wherein the wind turbine comprises a rotor having a hub and a plurality of rotor blades mounted to the hub, each rotor blade having a radially-outer, energy-extraction portion and a radially-inner, ventilation portion, wherein the radially-inner ventilation portion is shaped to, in use, ventilate a central area of the wake by extracting reduced levels of kinetic energy from the wind compared to the radially-outer energy extraction portion. The invention also provides a tangible computer-readable medium storing such computer-readable instructions.

The wind turbine may comprise one or more or all of the optional or preferable features discussed above.

The present invention will now be descried in greater detail by way of example only and with reference to the accompanying drawings, in which:

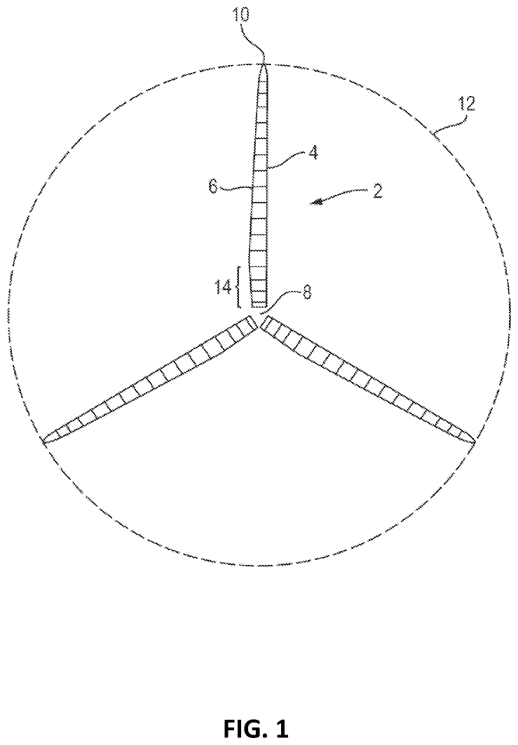

FIG. 1 illustrates three blades of a conventional prior art wind turbine;

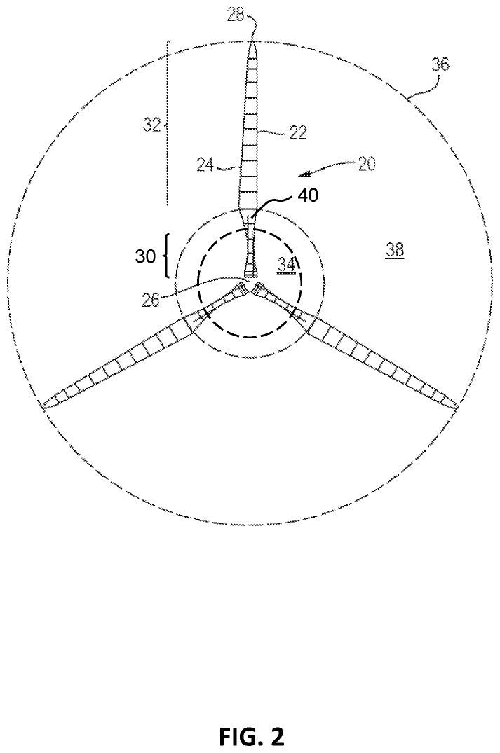

FIG. 2 illustrates three blades for a wind turbine that are designed to ventilate a central area of the wake of a wind turbine;

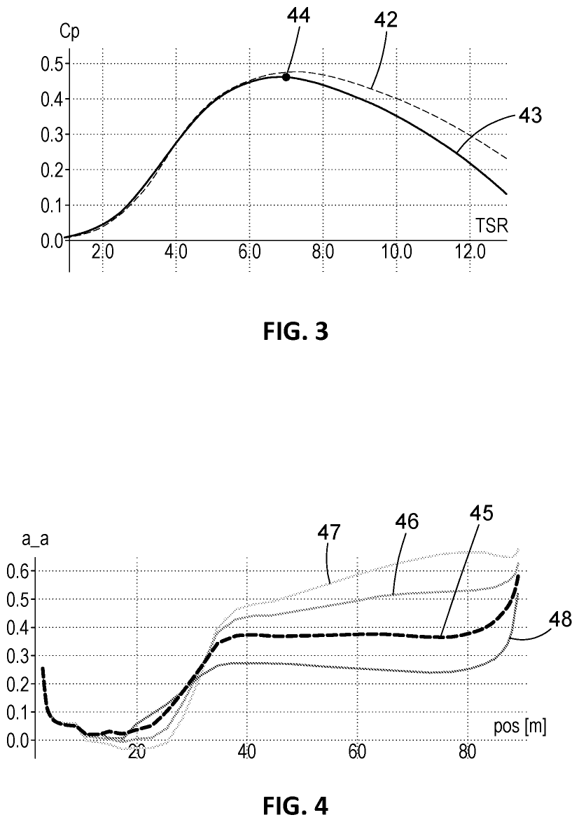

FIG. 3 is a graph showing how the power coefficient for the total swept area of a rotor varies with TSR;

FIG. 4 is a graph showing how the axial induction factor for a ventilated rotor varies with distance from the rotor hub for different TSRs;

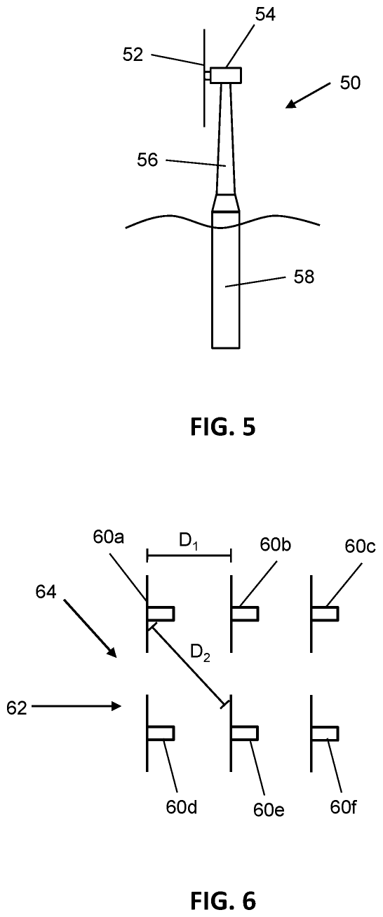

FIG. 5 is a side view of a floating wind turbine installation; and

FIG. 6 is a plan view of a wind farm.

FIG. 1 illustrates an example of a conventional rotor of a horizontal-axis wind turbine. The rotor comprises three blades 2 of identical shape. Each blade 2 is a set of aerofoil sections (with a radial-varying aerodynamically shaped section along its length) having a leading edge 4 and a trailing edge 6, which extend from a radially-inner root 8 of the blade 2 to a radially-outer tip 10. The blades 2 of the rotor are mounted via their roots 8 on a hub (not shown) such that, when wind passes through the rotor, lift is generated by each of the blades 2 in a direction perpendicular to the wind direction, causing the rotor to rotate.

In order to extract maximum energy from the wind, modern wind turbine blades 2 have a twist (of locally optimized aerofoils) along their length. This is because the optimal angle of attack of the blade 2 is primarily affected by the apparent local wind direction, which changes with radial position because local speed of the blade increases with increasing radial position. Thus, as the tip 10 of the blade 2 travels much faster than segments of the blade 2 closer to the hub of the rotor, the blades 2 incorporate a twist along their length so as to achieve the optimal angle of attack along the full length of the turbine blade 2.

It is noted that the radial blade angle of attack distribution will only be optimal at the wind turbine's design tip speed ratio (TSR). Usually, a rotor is designed based on the annual mean wind speed (e.g. in the North Sea, a wind speed of about 10 m/s) and a design TSR (e.g. a TSR of about 8 to 9). The rotor will be operated to achieve a constant TSR, at the design TSR, ideally from start-up up to rated wind speed (e.g. 12 m/s in the North Sea example), which will ensure optimal performance. Thus, during operation below the rated speed, the angle between the wind vector and the rotational speed vector does not change due to this constant TSR operation. Above the rated speed, the wind turbine blades are pitched to reduce the energy extracted from the wind in order to prevent excessive power production in the generator and damage to the wind turbine structure.

Typically, the blades 2 are designed so as to extract substantially uniform energy, i.e. to have a substantially uniform power coefficient, across the swept area 12 of the rotor except for the blade tip and root area. This achieves the highest coefficient of power for the swept area overall. A uniform power coefficient is achieved by increasing the chord length of the blade with decreasing radius (as can be seen in FIG. 1), so as to extract equal energy at the slower speeds as at the higher speeds.

For manufacturing reasons, a radially-inner portion 14 of the blade 2 is often designed with a shorter chord length than the chord length required to achieve the uniform power coefficient for the corresponding swept area. This is because the chord lengths required for uniform energy extraction at short radii are very high, and in some cases are beyond transport or manufacturing capabilities. Also, due to the non-linear nature of aerodynamics, highly complex aerodynamic designs are required to achieve sufficient power generation at short radii. However, the angle of attack of the radially-inner portion 14 is still at the optimal angle of attack and the radially-inner portion still achieves a moderate power coefficient.

FIG. 2 illustrates three blades 20 for a three-bladed rotor of a horizontal-axis wind turbine. These blades are shaped to provide a rotor that, in use, provides a wake with a ventilated central region. For this reason, it may be called a ventilated rotor.

Similar to the blades shown in FIG. 1, each blade 20 defines an aerofoil having a leading edge 22 and a trailing edge 24, which extend from a root 26 of the blade 20 to the tip 28 of the blade 20. The blades 20 of the rotor are mounted via their roots 26 on a hub (not shown) such that, when wind passes through the rotor, lift is generated by each of the blades 20 in a direction perpendicular to the wind direction, causing the rotor to rotate.

Each blade 20 is designed such that a radially-inner portion 30 of the blade 20 (such as 20% to 25% of the length of the blade 20) extracts reduced kinetic energy from the wind compared to a radially-outer portion 32 of the blade 20, at least when operating at and above the design TSR. As a result, during operation the radially-inner region of the wake will contain more kinetic energy compared to radially-outer region of the wake. This increased wind flow velocity at the centre of the wake generates additional shear stresses, with corresponding turbulence development, which gives rise to increased wake diffusion.

It should be appreciated that “extracting reduced kinetic energy” refers not only to extraction of useful energy to drive the turbine, but also to energy extraction due to drag or the like. For example, a root section having a circular shape will generate significant drag, which extracts energy from the flow and decreases ventilation.

In order to achieve the ventilation effect, the aerofoil blade shape of the radially-inner portion 30, at the rotor centre, is twisted and streamlined, see FIG. 2. Through these measures, a central ventilated area 34 of the rotor swept area 36 has a lower power coefficient compared with the radially-outer portion 38 of the rotor swept area 36.

For aerodynamic reasons, the blades 20 include a transition portion 40 between the radially-inner portion 30 and the radially-outer portion 32 where the blade 20 twists from the angle at the inner end of the radially-outer portion 32 to a blade angle at the outer end of the radially inner portion 30. The transition portion is about 10% of the length of the blade.

It will be appreciated that the power coefficient of the blades 20, and hence the kinetic energy extracted from the wind by the blades, will vary as the rotor is operated at different TSR. This is because, as the TSR changes, so does the apparent local wind direction along the length of the blade, meaning that the lift generated by the blade as the wind passes through the rotor will vary depending on the TSR of the rotor.

This is illustrated in FIG. 3, which is a graph showing how the power coefficient for the total swept area of a rotor varies with TSR. The graph shows a power coefficient curve 42 for a rotor comprising conventional blades, such as the blades 2 illustrated in FIG. 1, and a power coefficient curve 43 for a rotor having blades with a radially-inner ventilation portion, such as the blades 20 shown in FIG. 2.

Rotors have an optimal TSR, i.e. a design TSR, at which the highest power coefficient will be achieved for the total swept area of the rotor. This may, for example, occur at a TSR of about 7 to 10. The design TSR for the ventilated rotor is shown in FIG. 3 at point 44. The maximum power coefficient that can be achieved by the prior art rotor when it is operated at its design TSR is higher than the maximum power coefficient that can be achieved by the ventilated rotor of FIG. 2. This is because the radially-inner portion of the blades of the ventilated rotor are designed to extract less energy from the wind compared to typical prior art rotor blades. However, the difference between the maximum power coefficients of the rotors is minimal and may result in a loss of up to only 5%-10% in turbine efficiency.

The power coefficient of rotors falls away (i.e. is reduced) when the rotor is operated at above or below design TSR. Hence, it is possible to control the power output of the wind turbine by varying the TSR.

With continued reference to FIG. 2, the blades 20 are shaped so as to produce a more uniform power coefficient over the whole swept area 36 of the rotor when the turbine is operated at the design TSR compared to when the turbine is operated at above the design TSR. For the design shown in FIG. 2, the radially-outer portion 32 of the blades 20 are designed to achieve a relatively high power coefficient of about 40% across their swept area 38 and the radially-inner portion 30 of the blades are designed to achieve a relatively low power coefficient of about 10% across the central region 34 of the swept area 36, when the rotor is operated at the design TSR.

However, the blades 20 are shaped such that, when the rotor is operated at a TSR of about 1 or 2 above design TSR, the radially-outer portion 32 of the blades 20 achieve a power coefficient of about 45% across the swept area 38 and the radially-inner portion 30 of the blades achieve a power coefficient of about 5% across the central region 34 of the swept area 36.

As a result, the difference between the amount of kinetic energy that is extracted from the wind by the radially-inner portion of the swept area 34 of the rotor compared to the amount of kinetic energy extracted from the wind by the radially-outer portion of the swept area 38 will be larger when the rotor is operated at above the design TSR, compared to when the rotor is operated at the design TSR. It will therefore be appreciated that, with the rotor of FIG. 2, it is possible to control the difference between the speed of the air at the centre of the wake and the speed of the air at the outer region of the wake by adjusting the TSR of the rotor.

This is illustrated in FIG. 4 with reference to the axial induction factor, a, of the rotor. Axial induction factor a is the ratio of the difference in wind speed caused by the wind passing over the rotor to the wind speed upstream of the rotor and is given by:

$$a = \frac{{U}_{1} - {U}_{2}}{{U}_{1}}$$

where U₁ is the speed of the wind upwind of the rotor and U₂ is the speed of the wind at the rotor (e.g. directly behind the rotor).

Since this value is indicative of how the wind speed changes as the wind passes over the rotor, it is also indicative of how efficient the rotor is at extracting energy from the wind, i.e. the power coefficient.

FIG. 4 shows how the axial induction factor a for the ventilated rotor varies at increasing distances away from the rotor hub for different TSRs. In this example, the blades 20 have a length of 90 m and the radially-inner portion 30 of the blade 20 extends around 30 m from the blade root 26. Curve 45 shows the axial induction factor a at the design TSR. Curves 46 and 47 show the axial induction factor a at TSRs above the design TSR. Curve 46 shows the axial induction factor a when the rotor is operated at a TSR 1-2 above design TSR. As can be seen, the axial induction factor a over the radius of the rotor is more uniform when the rotor is operated at its design TSR compared to when the rotor is operated above its design TSR. Thus, the velocity of the wind within the wake will be more uniform when the rotor is operated at its design TSR compared to when the rotor is operated above its design TSR.

As discussed above, wake diffusion is caused by the generation of shear stresses within the wake which leads to turbulent mixing within the wake that, over a sufficient distance, leads to dissipation of the wake and wind speed recovery. These shear stresses are greater, leading to increased turbulence, when the velocity of the air within the wake is less uniform. It will therefore be appreciated that it is possible to control turbulent mixing within the wake, and hence wake diffusion, using the ventilated rotor of FIG. 2 by adjusting the TSR of the rotor. Specifically, turbulent mixing within the wake can be increased by operating the rotor at above its design TSR.

Curve 47 of FIG. 4 shows the axial induction factor a when the rotor is operated at a TSR 3-4 above its design TSR (i.e. at a higher TSR than curve 46). Operating the rotor at a TSR that is even further from its design TSR leads to a greater difference between the axial induction factor a at the radially-outer portion 38 of the rotor swept area 36 compared to the radially-inner portion 34 of the rotor swept area 36. As a result, the velocity of the wind within the wake will be even less uniform, leading to increased wake diffusion. However, at such a high TSR, the power output of the turbine may be dramatically curtailed and may outweigh the benefits obtained through this increased wake diffusion. It can also be seen from FIG. 4 that a radially-inner portion of curve 47 falls below 0. A negative axial induction factor a means that the rotor is acting as a propeller and imparting additional energy to the wake. This will increase the speed of the wind downwind of the radially-inner portion 34 of the rotor, resulting in increased shear stresses and increased wake diffusion. However, this effect will also contribute to reducing the power output of the turbine.

Curve 48 shows the axial induction factor a when the rotor is operated below the design TSR, i.e. at 1-2 below the design TSR. Below the design TSR, the axial induction factor a over the radius of the rotor is more uniform than when the rotor is operated at its design TSR. This will lead to decreased wake diffusion. Moreover, the axial induction factor a for the radially-outer portion 38 of the rotor swept area 36 is lower than the axial induction factor a for the same region when the rotor is operated at the design TSR, indicating that less energy is extracted by the radially-outer region 38 when the rotor is operated below design TSR. As a result, the power output of the turbine will be reduced compared to operation at the design TSR.

Operation of a wind turbine comprising a rotor as depicted in FIG. 2 will now be described with respect to FIGS. 5 and 6. FIG. 5 illustrates a floating wind turbine assembly 50. It comprises a turbine rotor 52 mounted to a nacelle 54. The nacelle is in turn mounted to the top of a tower 56 secured to the top of a floating platform 58, which in the example shown is a spar-buoy like structure. Whilst this example shows a floating offshore wind turbine, the methods described herein are applicable to all horizontal-axis wind turbines, including land based wind turbines. The floating platform 58 may be secured to the sea bed by one or more anchor lines (not shown), these could be taut or catenary mooring lines. The nacelle 54 contains an electrical generator which is connected to the rotor 52 to generate electrical power. The nacelle also contains a controller for controlling operation of the wind turbine 50.

FIG. 6 is a plan view of a wind turbine array comprising a plurality of floating wind turbines 60a-f of the type shown in FIG. 5.

It will be appreciated that in most wind turbine arrays the distance between the wind turbines, in the direction of the wind, will vary as the wind direction changes. For instance, in the wind farm shown in FIG. 6 when the wind approaches in the direction of arrow 62 the spacing D₁ between an upwind turbine 60a and a downwind turbine 60b is about 10 rotor diameters in length. However, when the wind approaches in direction of arrow 64, the spacing D₂ between the upwind turbine 60a and a downwind turbine 60e is about 15 rotor diameters. Thus, there will be a larger distance between the wind turbines for wake dissipation to occur when the wind approaches from direction 64 compared to when the wind approaches from direction 62. As a result, the effect of the wake from an upstream wind turbine on the power output of a downwind wind turbine may be greater when the wind approaches from direction 62 compared to when the wind approaches from direction 64. Hence, wake induced efficiency losses within the array will vary depending on the direction of the wind.

When the wind approaches from direction 64, the upstream turbine 60a may be operated at the design TSR, e.g. a TSR of about 10, in order to maximise power output of the wind turbine 60a. The ventilation effect of the rotor will cause the wake to diffuse, and the wake may only have a minimal effect on the power output of the downwind turbine 60e. In this example, the wake is caused to diffuse sufficiently over spacing D₂ so that the wake induced power output loss experienced by the downwind turbine 60e is less than 20% compared to the power output of the upwind turbine 60a.

This loss in performance may be outweighed by operating the upstream wind turbine 60a at the design TSR thereby maximising power output of the upstream wind turbine, and may lead to optimum power output across the turbine array.

However, when the wind approaches the upstream turbine 60a along direction 62, the wake from wind turbine 60a will have less distance, i.e. D₁, over which to dissipate before reaching the downwind wind turbine 60b. Hence, if the speed of the approaching wind is the same as the scenario discussed above, and the upwind turbine 60a were operated at the design TSR then the wake induced power output loss experienced by the downwind turbine 60b would be greater than that experienced by the downwind wind turbine 60e in the example discussed above. For example, the wake induced power output loss experienced by the downwind turbine 60b may be more than 50% compared to the power output of the upwind turbine 60a. In such a scenario, operating the upwind wind turbine 60a at the design TSR may not lead to optimum power output of the wind farm as a whole.

In order to reduce the wake induced efficiency losses, the upwind wind turbine 60a may be operated at a TSR of about 2 above its design TSR, i.e. at a TSR of about 12. As discussed above, this will lead to increased turbulence in the wake as a result of the increased ventilation effect of the central region 34 of the rotor, thereby leading to increased wake diffusion. This will reduce the effect of the wake on the downwind wind turbine 60b, and lead to reduced wake induced power output losses. For example, the wake induced power output loss experienced by the downwind turbine 60b may be reduced from about 50% when the upwind wind turbine is operated at the design TSR to less than 30% when the upwind wind turbine 60a is operated at above the design TSR.

Although operating the upwind wind turbine 60a at a TSR above its design TSR will lead to a reduction in the power output of the wind turbine 60a (as discussed above), this may be outweighed by the increase in power output of the downwind wind turbine 60b. Hence, in certain wind conditions, increasing the TSR of the upwind turbine 60a to above its design TSR may increase the power output of the wind farm as a whole.

It will therefore be appreciated that that the TSR of a wind turbine, such as the wind turbine 60a, can be adjusted in order to control turbulent mixing within, and therefore diffusion of, its wake in order to control the effect that the wake has on all downwind turbines.

This control can be used to obtain an optimum balance between the power output of an individual wind turbine and diffusion of its wake in order to optimise power output of an array of wind turbines by limiting the effect of the wake on downwind turbines.

The TSR of a wind turbine may be adjusted by altering the blade pitch angle of the rotor blades 20. In order to increase the TSR, the blade pitch angle of the blades 20 may be reduced in order to increase aerodynamic lift generated by the blades 20, leading to an increase in the rotational velocity of the rotor. Conversely, the TSR of the rotor may be reduced by increasing the blade pitch angle of the blades 20 so as to reduce the aerodynamic lift generated by the blades 20.

Alternatively, or in addition, the TSR may be controlled by adjusting the torque presented to the rotor by the generator. Increasing the resistive torque of the generator will lead to a reduction in the TSR, whilst reducing the resistive torque will result in an increase in the TSR.

Whilst the wind turbines in FIG. 6 are shown facing into the wind directed along arrow 62, it will be appreciated that as the direction of the wind changes, the wind turbines may be yawed so that their rotors face directly into the oncoming wind.

The control techniques described above for varying the wake diffusion effect of the rotor may only be necessary when the speed of the wind is below rated wind speed. For a wind turbine in the North Sea, the rated wind speed may be about 10 ms⁻¹ to 13 ms⁻¹. At or above the rated wind speed the rotor may be operated at a TSR below the design TSR and controlled so as to generate a constant output power and prevent excessive power production. This constant, maximum, power is known as the rated power of the wind turbine, and may be around 5 MW to 20 MW.

A constant power output is achieved by controlling the pitch of the blades 20 of the wind turbine 42 in order to control and limit the lift generated by the blades 20 and thereby prevent excessive power and thrust production and damage to the wind turbine structure. As a result, only a relatively small amount of kinetic energy may be extracted from the wind by the rotor at or above the rated wind speed, and hence no substantial wake may be generated behind the rotor. That is, the wake may not result in a significant (e.g. greater than 20%) loss in power output of a downwind turbine. Hence, at or above rated wind speed, the TSR may be controlled only to ensure that the wind turbine produces a constant power output, with no additional control provided in order to control diffusion of the wake.

Referring again to FIG. 5, the TSR of the rotor 52 may be controlled by the controller arranged within the nacelle 54 of the wind turbine 50. The controller may be arranged to control the pitch of the blades and/or the torque presented to the rotor 52 by the generator. The controller may be arranged to control the TSR based on the direction of the wind, the wind velocity at the wind turbine and the known locations of other wind turbines relative to the wind turbine. In this way, the controller is able to determine the TSR that is required to provide an optimum balance between the power output of the individual wind turbine and wake diffusion effects. To this end, the controller comprises a memory for storing the relative locations of other wind turbines close to the wind turbine.

The wind turbine 50 may also include one or more sensors to measure the direction and velocity of the wind at the wind turbine 50. The sensors may be arranged in communication with the controller to pass the wind direction and wind velocity data to the controller. The controller may be arranged to use this data, together with the known positions of other nearby wind turbines, to calculate the optimum TSR of the wind turbine and adjust the blade pitch of each blade 20 and/or the torque provided by the generator accordingly to achieve the determined TSR.

For a wind turbine array, the optimum operational TSR for each wind turbine in the array for achieving maximum array efficiency may be calculated by a centralised controller. The centralised controller may be arranged in communication with each of the wind turbines (e.g. with the controller of each of the turbines) in the array. The centralised controller may use data representative of the speed of the wind, direction of the wind and the relative positions of the wind turbines in the array in order to calculate the optimum operational TSRs for each of the wind turbines in the array. This data may be fed into a model of the array in order to calculate the optimum operational TSRs. Once they have been determined, the centralised controller may communicate the optimum operational TSRs to the local wind turbine controllers, which may then control the wind turbines to adjust their TSRs (as necessary) to match their respective optimum operational TSR.

Wind speed and direction data for use in these calculations may be communicated to the centralised controller from the local controllers of the wind turbines. For instance, wind speed and direction data obtained by the sensors on one or more of the wind turbines may be passed to the centralised controller. The centralised controller may store data indicative of the relative positions of the wind turbines for use in determining the optimum operational TSRs.

As will be appreciated, by controlling the TSR of a wind turbine as described above, it is possible to obtain an optimum balance between the power output of the wind turbine and the wake diffusion effects of the rotor. This makes it possible to maximise the power generated by an array of wind turbines by optimising the wake diffusion effects of the rotor to minimise wake efficiency loses within the array.

1-25. (canceled)

26. A method of controlling diffusion of a wake generated by a horizontal axis wind turbine, wherein the wind turbine comprises a rotor having a hub and a plurality of rotor blades mounted to the hub, wherein each rotor blade has a radially-outer, energy-extraction portion and a radially-inner, ventilation portion, and wherein the radially-inner ventilation portion is shaped to, in use, ventilate a central area of the wake by extracting reduced levels of kinetic energy from the wind compared to the radially-outer energy extraction portion, the method comprising:
adjusting the tip speed ratio of the rotor so as to modify turbulent mixing within the wake.

27. The method according to claim 26, wherein the radially-inner portion of each blade and the radially-outer portion of each blade have an aerofoil shape.

28. The method according to claim 26, wherein the adjustment to the tip speed ratio of the rotor is based on a property of the wind at the wind turbine and/or a location of the wind turbine relative to another wind turbine.

29. The method according to claim 26, wherein adjusting the tip speed ratio of the rotor comprises adjusting the tip speed ratio so as to reduce wake induced power output losses experienced by another wind turbine positioned downwind of the wind turbine.

30. The method according to claim 29, further comprising adjusting the tip speed ratio of the rotor so that the wake induced power output losses experienced by the downwind wind turbine are less than a predetermined threshold level, wherein the tip speed ratio of the rotor is adjusted to maximize the power output of the wind turbine whilst maintaining the wake induced power output losses experienced by the downwind wind turbine below the predetermined threshold level.

31. The method according to claim 26, comprising operating the rotor at a tip speed ratio above its design tip speed ratio so as to provide increased turbulent mixing within the wake compared to when the rotor is operated at its design tip speed ratio.

32. The method according to claim 26, wherein adjusting the tip speed ratio of the rotor comprises increasing the tip speed ratio above its design tip speed ratio so as to increase turbulent mixing within the wake; and/or
wherein adjusting the tip speed ratio of the rotor comprises reducing the tip speed ratio of the rotor to its design tip speed ratio to optimize the power output of the wind turbine.

33. The method according to claim 26, wherein adjusting the tip speed ratio of the rotor comprises adjusting the blade pitch of the rotor blades; and/or
wherein the wind turbine comprises a generator coupled to the rotor to generate electrical power, and adjusting the tip speed ratio of the rotor comprises adjusting the torque presented to the rotor by the generator.

34. The method according to claim 26, wherein adjusting the tip speed ratio of the rotor in order to modify turbulent mixing within the wake is performed only when the speed of the wind at the wind turbine is below rated wind speed; and/or
wherein the method further comprises, at wind speeds at or above rated wind speed, controlling the tip speed ratio of the rotor so that the wind turbine produces a constant output power.

35. A horizontal-axis wind turbine comprising:
a tower;
a rotor mounted at the top of the tower, wherein the rotor comprises a hub and a plurality of rotor blades mounted to the hub, each rotor blade having a radially-outer, energy-extraction portion and a radially-inner, ventilation portion, wherein the radially-inner ventilation portion is shaped to, in use, ventilate a central area of the wake by extracting reduced levels of kinetic energy from the wind compared to the radially-outer energy extraction portion; and
a controller configured to control the wind turbine in accordance with the method of claim 26.

36. The wind turbine according to claim 35, comprising a memory for storing data relating to the location of other wind turbines relative to the location of the wind turbine.

37. The wind turbine according to claim 35, comprising one or more sensors for measuring the direction and/or velocity of the wind at the wind turbine.

38. The wind turbine according to claim 35, wherein the rotor blades are shaped so as to produce a more uniform power coefficient over the total swept area of the rotor when the rotor is operated at its design tip speed ratio compared to when the rotor is operated at tip speed ratios away from its design tip speed ratio; and/or
wherein each blade comprises a transition portion between the radially-inner portion and the radially-outer portion, the transition portion transitioning smoothly from a local blade twist angle and/or aerodynamic shape of the radially-outer portion to a local blade twist angle and/or aerodynamic shape of the radially-inner portion.

39. The wind turbine according to claim 35, wherein the wind turbine comprises an offshore wind turbine, preferably a floating offshore wind turbine.

40. The wind farm comprising an array of horizontal-axis wind turbines, at least one of the wind turbines being a wind turbine in accordance with claim 35.

41. A method of optimizing power production of a wind farm comprising a plurality of horizontal axis wind turbines, the wind turbines comprising a rotor having a plurality of rotor blades, each rotor blade having a radially-outer, energy-extraction portion and a radially-inner, ventilation portion, wherein the radially-inner ventilation portion is shaped to, in use, ventilate a central area of the wake by extracting reduced levels of kinetic energy from the wind compared to the radially-outer energy extraction portion, the method comprising:
determining the effect that the wake of each wind turbine has on the efficiency of the wind farm; and
adjusting the tip speed ratio of the rotor of at least one of the wind turbines to modify turbulent mixing within its wake and increase the efficiency of the wind farm.

42. The method according to claim 41, wherein determining the effect of the wakes comprises using properties of the wind, such as wind speed and/or direction, and the relative positions of the wind turbines to determine the effect that the wake produced by each wind turbine has on other wind turbines in the wind farm.

43. The method according to claim 41, comprising operating the rotor of at least one of the wind turbines at a tip speed ratio above its design tip speed ratio so as to provide increased turbulent mixing within its wake compared to when the rotor is operated at its design tip speed ratio.

44. The method according to claim 41, wherein adjusting the tip speed ratio comprises reducing the tip speed ratio so as to decrease turbulent mixing within the wake and increase the power output of the wind turbine.

45. The method according to claim 41, comprising controlling the tip speed ratio of each of the wind turbines to reduce wake induced efficiency losses within the wind farm and maximize the efficiency of the wind farm.
